(19) United States
(12) Patent Application Publication
(10) Pub. No.: US 2019/0232928 A1
(43) Pub. Date: Aug. 1, 2019

(54) SENSOR UNIT

(71) Applicant: TOYOTA JIDOSHA KABUSHIKI KAISHA, Toyota-shi (JP)

(72) Inventors: Kazuhiro ADACHI, Chita-gun (JP); Hiroshi ISONO, Susono-shi (JP)

(73) Assignee: TOYOTA JIDOSHA KABUSHIKI KAISHA, Toyota-shi (JP)

(21) Appl. No.: 16/247,891

(22) Filed: Jan. 15, 2019

(30) Foreign Application Priority Data
Feb. 1, 2018 (JP) 2018-016350

(51) Int. Cl. B60T 7/04; B60T 13/66; B60T 11/18; B60T 13/74; G01D 5/14

(52) U.S. Cl. CPC B60T 7/042; B60T 13/662; B60T 2220/04; B60T 13/745; G01D 5/142; B60T 11/18

(57) ABSTRACT

A sensor unit capable of detecting a step-on operation on a foot pedal with high accuracy is configured without inviting cost increase. The unit includes a linear movement member to which an arcuate motion at time of a step-on operation on a foot pedal disposed in a vehicle cabin space is transmitted as being converted into a linear motion by a converter mechanism, and a detection section detecting the linear motion of the linear movement member inside the vehicle cabin space.

### CROSS REFERENCE TO RELATED APPLICATIONS

This application is based on and claims priority under 35 U.S.C § 119 to Japanese Patent Application 2018-016350, filed on Feb. 1, 2018, the entire content of which is incorporated herein by reference.

### TECHNICAL FIELD

This disclosure relates to a sensor unit configured to detect a pedal operation as an electric signal.

### BACKGROUND DISCUSSION

As a sensor unit configured as above, Japanese Unexamined Patent Application Publication No. 2015-98289 (hereinafter, JP2015-98289A) discloses a technique according to which a brake device having a master cylinder activated according to a rod activated by an operation on a brake pedal is provided with a stroke sensor for detecting an activation amount of a piston.

The sensor unit disclosed in this JP2015-98289A is attached to one lateral face of a master cylinder unit, the sensor unit having a permanent magnet and a hall element and being configured to detect a stroke of a primary piston via magnetism.

Japanese Unexamined Patent Application Publication No. 2015-107749 (hereinafter, JP2015-107749A) discloses a technique in which a stroke sensor is attached to a lateral face of a base having a master cylinder operably by a brake pedal.

In this JP2015-107749A, an activation stroke of a primary piston can be detected by the stroke sensor.

### SUMMARY

As an example of a foot pedal provided in a vehicle such as an automobile, a brake pedal can be cited. In this connection, according to techniques disclosed in JP2015-98289A and JP2015-107749A, an actual brake operation amount can be acquired through detection of an activation amount of a piston within a master cylinder.

However, since the master cylinder is configured to apply a pressure to brake oil by means of the piston mounted therein, a housing for this master cylinder is manufactured with using a metal material such as cast iron in order to be able to withstand the pressure and a metal material is used also in the piston.

Further, in the case of constituting a stroke sensor of a combination of a permanent magnet and a magnetic sensor such as a hall element (sensor), it is possible to obtain a predetermined accuracy in non-contact manner. However, in the case of an arrangement e.g. that the magnetic sensor such as a hall element is mounted outside the master cylinder and the permanent magnet is mounted to a movable portion such as a piston, the large distance between the permanent magnet and the magnetic sensor would lead to deterioration in the detection accuracy.

Especially, if the housing for the master cylinder is formed of iron material, the magnetic flux from the permanent magnet can readily migrate to the housing of the master cylinder, thus inviting deterioration in the detection accuracy. Also, in an arrangement e.g. in which the sensor unit is disposed in vicinity of the piston, improvement of sealing performance would be required for suppressing leakage of brake oil from the piston.

In order to dissolve such inconveniences as described above, it is conceivable to employ a costly permanent magnet having a high magnetic flux density or to employ non-magnetic material in the housing for the master cylinder. However, these would invite cost increase.

For the reasons mentioned above, there is a need for obtaining a sensor unit capable of detecting a step-on operation on a foot pedal with high accuracy, without inviting cost increase.

According to a characterizing feature of this disclosure, a sensor unit comprises: a linear movement member to which an arcuate motion at time of a step-on operation on a foot pedal disposed in a cabin space of a vehicle is transmitted as being converted into a linear motion by a converter mechanism; and a detection section detecting the linear motion of the linear movement member inside the vehicle cabin space.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of a sensor unit,

FIG. 2 is a section view of the sensor unit, and

FIG. 3 is an enlarged section view of a detection section.

### DETAILED DESCRIPTION

Next, an embodiment of the present disclosure will be explained.

[Basic Configuration]

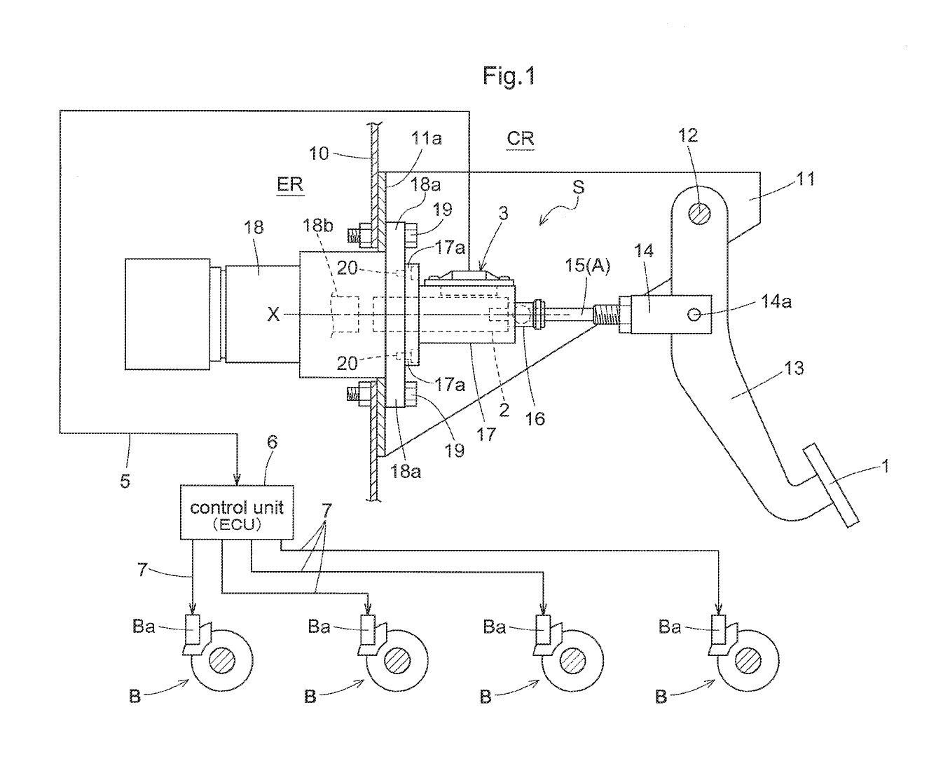

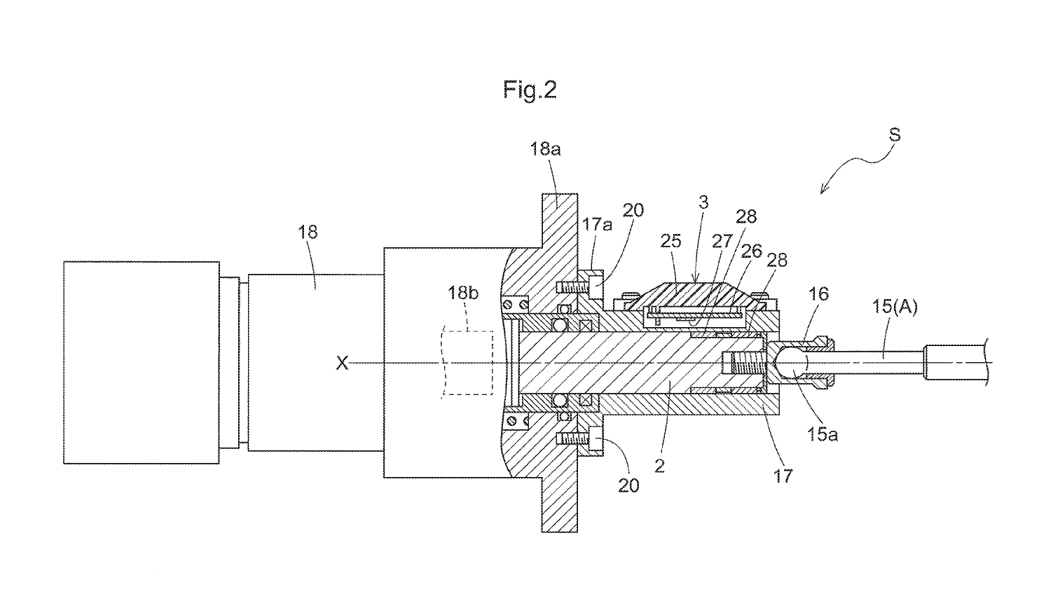

As shown in FIG. 1 and FIG. 2, a sensor unit S includes a linear movement member 2 which effects a linear motion at time of a step-on operation on a foot pedal 1 and a detection section 3 for detecting a displacement amount at time of the linear motion of the linear movement member 2. This sensor unit S is configured such that an arcuate motion of a foot pedal operational system associated with an operation of the foot pedal 1 when stepped-on is converted into a linear motion by a converter mechanism A and transmitted as such to the linear movement member 2, whereby the linear movement member 2 is moved linearly along a direction of an axis X.

In the same figures, there is shown a brake system mounted in a vehicle such as an automobile. In this brake system, an activation amount of the linear movement member 2 at time of the step-on operation on the braking foot pedal 1 is electrically detected by the detection section 3 and a resultant detection signal from the detection section 3 is acquired by a control unit 6 via a detection wire 5, whereby a braking force required by the control unit 6 is set. And, as the control unit 6 controls an actuator Ba of each brake device B via an output wire 7 so as to obtain the set braking force, there is realized braking control by a braking force corresponding to the stepped-on amount.

As this brake system controls the brake device B by electric control, it does not require pipes or brake oil unlike a system using brake oil, so setting of baking timings and braking forces of a plurality of brake devices B can be done easily.

Incidentally, this sensor unit S may be used alternatively for detecting an activation amount of the linear movement member 2 in a brake system configured such that an activation of the linear movement member 2 is transmitted to a piston of a master cylinder and brake oil is supplied from this piston to the brake devices B.

[Sensor Unit]

As shown in FIG. 1, a support frame 11 is attached to a partition wall 10 partitioning an engine room ER of the vehicle and a vehicle cabin space CR where a driver's seat (not shown) is disposed. To this support frame 11, there is pivotally supported a pedal arm 13 via a horizontally oriented pivot shaft 12, and a foot pedal 1 is provided to this pedal arm 13.

At an intermediate portion of the pedal arm 13, a clevis 14 is supported via a clevis pin 14a, and to this clevis 14, one end side (the right side in FIG. 1) of a rod member 15 is pivotally supported and the other end side (the left side in FIG. 1) of the rod member 15 is placed in contact with an end portion of the linear movement member 2 via a pressure receiving mechanism 16.

The rod member 15 constitutes a converter mechanism A configured to convert an arcuate motion of the pedal operational system (specifically, an arcuate motion of the pedal arm 13) associated with an operation of the foot pedal 1 when this foot pedal 1 is stepped on into a linear pushing operational force by the rod member 15. For enabling this conversion, one end portion of the rod member 15 is connected to the pedal arm 13 via the clevis 14, as described above and a ball-like portion 15a (see FIG. 2) formed at the other end portion is inserted to the inner space of the pressure receiving mechanism 16.

The linear movement member 2 is accommodated within a guide member 17 which as a whole is formed tubular to be linearly movable, and this guide member 17 is supported to a reaction force unit 18. Incidentally, the guide member 17 has a cylindrical inner circumferential face coaxial with the axis X, and the linear movement member 2 is accommodated within the tubular guide member 17 to be linearly movable as being in slidable contact with this inner circumferential face.

The reaction force unit 18 is disposed in an area extending from the vehicle cabin space CR to the engine room ER. This reaction force unit 18 includes a flange portion 18a to be connected to the partition wall 10 and accommodates therein an activating member 18b to which the inner end (the left side in FIG. 1) of the linear movement member 2 is placed in contact and a spring e.g. a compression coil type or the like for applying a reaction force to this activating member 18b.

Then, as the flange portion 18a of this reaction unit 18 and a base end portion 11a of the support frame 11 are overlapped with each other, these members are fixed to the partition wall 10 via connecting bolts 19.

The guide member 17 integrally forms a flange member 17a at its end adjacent the reaction force unit 18, and with this flange member 17a being placed in contact with an outer face of the flange portion 18a of the reaction force unit 18, the guide member 17 is fixed to the reaction force unit 18 via fixing bolts 20.

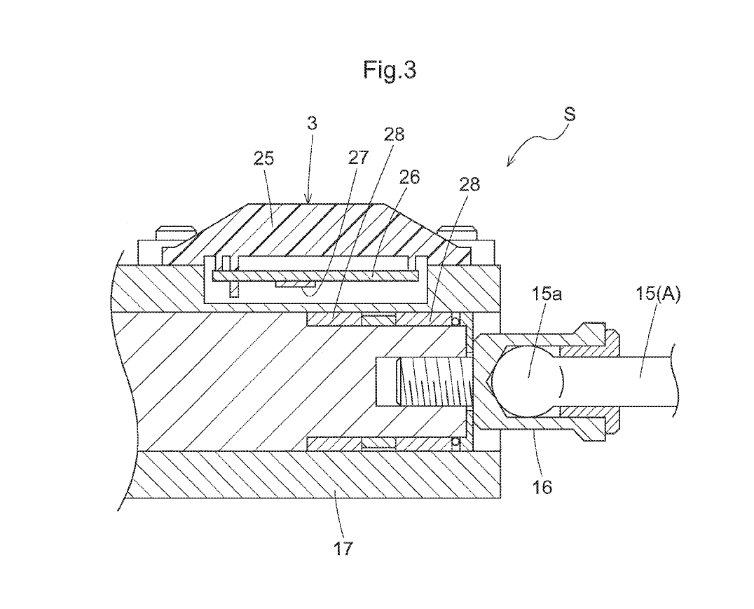

As shown in FIG. 2 and FIG. 3, the outer end portion (the right side in FIG. 2) of the linear movement member 2 is fixed to the pressure receiving mechanism 16 via threading engagement therewith. This pressure receiving mechanism 16 defines a recess portion coaxial with the axis X, and in this recess portion, the ball-like portion 15a formed at the end portion of the rod member 15 is fitted.

As the material for forming the guide member 17, there is employed a non-magnetic metal, or engineering plastic, or the like, and to its upper face, there is supported a detection case 25 constituting the detection section 3. And, on the lower face side of this detection case 25, a detection circuit board 26 is provided. This detection circuit board 26 includes a hall IC 27 (an example of a “magnetic sensor”) having hall elements. Further, in the outer circumference of the linear movement member 2, annular permanent magnets 28 are fitted side by side along the axis X.

Incidentally, as the engineering plastic, it is possible to employ polyacetal, polyamide, polycarbonate, etc. The detection case 25 is formed of an insulating resin.

[Modes of Detection in Detection Section]

According to this configuration, when the foot pedal 1 is stepped on, the one end side of the rod member 15 constituting the converter mechanism A is relatively pivoted about the clevis pin 14a of the clevis 14. Also, the ball-like portion 15a provided on the other end side of the rod member 15 is relatively pivoted within the recess portion of the pressure receiving mechanism 16. With this, the arcuate motion of the foot pedal 1 is converted into a linear motion by the rod member 15. As a result, the linear movement member 2 effects a linear motion.

The detection section 3 is comprised of the hall IC 27 mounted on the detection circuit board 26 and the pair of permanent magnets 28 provided in the linear movement member 2. With this arrangement, in the detection section 3, in association with a step-on operation on the foot pedal 1, when the linear movement member 2 is linearly activated along the axis X, magnet flux density applied from the pair of permanent magnets 28 to the hall IC 27 varies. And, based on a change in an electric signal detected by the hall IC 27 in association with the above variation, the movement amount is detected with high accuracy.

[Function/Effect of Embodiment]

According to this configuration when the foot pedal 1 is stepped on, an arcuate motion of the pedal operational system is converted into a linear motion by the converter mechanism A and transmitted as such to the linear movement member 2, so the linear movement member 2 effects a linear motion. As this linear motion is detected by the detection section 3, detection accuracy of the displacement amount is improved in comparison with e.g. an arrangement in which a displacement of a member including a non-linear motion component is detected.

With the above configuration, since the detection section 3 is provided in the vehicle cabin space CR, in comparison with e.g. an arrangement for detecting a motion of a piston of a master cylinder of a brake system of a vehicle, it has become possible to configure the detection section 3 to be capable of detecting a relative motion between the linear movement member 2 and a stationary member, the configuration is simple and can be formed compact as well and also wiring layout is easy, so that the readiness of maintenance too is improved.

Further, with this configuration, since the detection section 3 is provided in the vehicle cabin space CR, the amount of temperature variation is smaller than an arrangement of the detection section 3 being disposed in the engine room ER, and the possibility of accidental contact by dust is lower also. Further, with suppression of influence from the environment, the state less likely to invite damage can be maintained.

As the converter mechanism A is constituted of the rod member 15, the configuration of this converter mechanism A is simplified. Further, by supporting the linear movement member 2 to the guide member 17 disposed in the vehicle cabin space CR and disposing the permanent magnets 28 and the magnetic sensor to be able to detect a relative motion between the guide member 17 and the linear movement member 2, the configuration of the detection section 3 is simplified and manufacture thereof is easy as well.

With this sensor unit S, when the foot pedal 1 is stepped on, a reaction force is applied from the reaction force unit 18 to the foot pedal 1. So, a stepped-on amount or a stepped-on force can be grasped via a driver's operational feel. In particular, it is possible to set the control mode of the control unit 6 such that the higher the operational reaction force at time of step-on operation on the foot pedal 1, the greater the braking force provided by the brake device B. And, with setting such control mode, it becomes possible to cause the driver to recognize the braking force based on feel at time of step-on operation on the foot pedal 1.

### Other Embodiments

This disclosure can alternatively be configured as follows instead of the foregoing embodiment (those having the identical functions as the foregoing embodiment will be denoted with identical numerals/marks to those of the foregoing embodiment).

(a) The magnetic sensor is not limited to the hall element or the hall IC 27, but can employ a magnetic resistance effect element or a differential transformer, etc. instead. With such alternative configurations of the magnetic sensor too, the effectiveness of the sensor unit S will not be impaired. Further, the detection section 3 can be configured such that the magnetic sensor is provided in the linear movement member 2 and the permanent magnets 28 are provided in a stationary system such as the guide member 17, etc.

(b) The converter mechanism A can be alternatively configured such that the arcuate motion at time of step-on operation on the foot pedal 1 is converted into a linear motion by means of a pinion gear which is rotated in association with a pivotal movement of the pedal arm 13 at time of step-on operation on the foot pedal 1 and a rack gear meshing therewith or can be configured such that an operational force of the foot pedal 1 is applied to the linear movement member 2 by applying a pressure thereto linearly via liquid.

(c) This sensor unit S can be used not only to operate the brake of the vehicle as the foot pedal 1, but can be used for a clutch pedal or a pedal for realizing other controls. Further, as described in the foregoing detailed disclosure, it may be applied also to a foot pedal 1 of a brake system using brake oil.

This disclosure can be utilized in a sensor unit that detects a pedal operation as an electric signal.

As described above, according to a characterizing feature of this disclosure, a sensor unit comprises: a linear movement member to which an arcuate motion at time of a step-on operation on a foot pedal disposed in a cabin space of a vehicle is transmitted as being converted into a linear motion by a converter mechanism; and a detection section detecting the linear motion of the linear movement member inside the vehicle cabin space. With this characterizing feature, when the foot pedal is stepped on, an arcuate motion associated with this foot pedal operation is converted into a linear motion by the converter mechanism, so the linear movement member effects a linear motion. And, this linear motion of the linear movement member is detected by the detection section disposed inside a vehicle cabin space. For instance, in comparison with an arrangement of detecting a displacement of a member having a non-linear motion component, detection accuracy of the displacement amount is improved. Further, with the inventive arrangement, the detection section is provided inside the vehicle cabin space. Thus, in comparison with an arrangement of detecting a motion of a piston of a master cylinder of a vehicle brake system, the detection section can be configured to detect a relative motion between the linear movement member and a stationary member, so the arrangement can be simple and compact, and wiring layout is easy, so that the easy of maintenance is improved also.

Moreover, in the case of the arrangement having a detection section configured to detect a motion of a piston of a master cylinder, it is necessary to consider the sealing performance of the piston. Furthermore, in case the housing of the master cylinder is formed of a magnetic material and a magnetic sensor is employed as the detection section, it is necessary to contemplate use of a permanent magnet having high magnetic flux density. On the other hand, in the case of the inventive arrangement described above, there is no need to take such sealing performance of the linear movement member into consideration. So, even with use of a magnetic sensor, there is no need to employ a permanent magnet having high magnetic flux density, either. Accordingly, it has become possible to configure a sensor unit capable of detecting a step-on operation on a foot pedal with high accuracy, without inviting cost increase.

According to a further characterizing feature: the converter mechanism includes a rod member having one end thereof supported to the foot pedal and the other end thereof configured to apply a pressing force to an end portion of the linear movement member; the linear movement member is supported to be capable of the linear motion by a guide member disposed in the vehicle cabin space; and the detection section includes a permanent magnet provided in one of the guide member and the linear movement member and a magnetic sensor provided in the other of the guide member and the linear movement member.

With the above-described arrangement, since the converter mechanism includes a rod member, the configuration of this converter mechanism can be simple. Further, since the linear movement member is supported to a guide member provided inside the vehicle cabin space and the detection section can be configured by disposing a permanent magnet and a magnetic sensor so as to be capable of detecting a relative motion between the guide member and the linear movement member, the configuration of the detection section can be simple and its manufacture is easy.

1. A sensor unit comprising:
a linear movement member to which an arcuate motion at time of a step-on operation on a foot pedal disposed in a cabin space of a vehicle is transmitted as being converted into a linear motion by a converter mechanism; and
a detection section detecting the linear motion of the linear movement member inside the vehicle cabin space.

2. The sensor unit of claim 1, wherein:
the converter mechanism includes a rod member having one end thereof supported to the foot pedal and the other end thereof configured to apply a pressing force to an end portion of the linear movement member;
the linear movement member is supported to be capable of the linear motion by a guide member disposed in the vehicle cabin space; and
the detection section includes a permanent magnet provided in one of the guide member and the linear movement member and a magnetic sensor provided in the other of the guide member and the linear movement member.
